(19) United States
(12) Patent Application Publication
(10) Pub. No.: US 2002/0158155 A1
(43) Pub. Date: Oct. 31, 2002

(54) Fuel injection valve

(76) Inventor: Wolfgang Mertzky, Schwieberdingen (DE)

Correspondence Address: KENYON & KENYON, ONE BROADWAY, NEW YORK, NY, 10004, US

(21) Appl. No.: 09/913,474

(22) PCT Filed: Dec. 14, 2000
(86) PCT No.: PCT/DE00/04451

(30) Foreign Application Priority Data
Dec. 15, 1999 (DE) 199 60 340.5

(51) Int. Cl. F02M 51/00

(52) U.S. Cl. 239/585.1

(57) ABSTRACT

A fuel injector (1), especially a fuel injector (1) for directly injecting fuel into a combustion chamber of an internal combustion engine, includes a preferably disk-shaped valve-closure member (8) which forms a sealing seat with a sealing body (10). The fuel injector (1) is opened and closed by rotating the valve-closure member, using an electric motor (2).

### BACKGROUND INFORMATION

The present invention is based on a fuel injector of the type set forth in the main claim.

Fuel injectors for injecting fuel directly into the combustion chamber of an internal combustion engine are usually actuated either electromagnetically or by a piezoelectric or by a magnetostrictive actuator.

As an example, from DE 196 26 576 A1 an electromagnetically operable fuel injector is known, in which, for the electromagnetic actuation, an armature cooperates with an electrically energizable magnetic coil, and the lift of the armature is transmitted to a valve-closure member via a valve needle. The valve-closure member interacts with a valve-seat surface to form a sealing seat. The valve needle and the valve-closure member are reset by a restoring spring.

A field current is applied to the magnetic coil to operate the fuel injector, whereby the armature is drawn into the magnetic coil, and the fuel injector is opened by the lifting of the valve-closure body from the valve seat surface.

The main disadvantage of the fuel injector known from DE 196 26 576 A1 is the relatively long closing times. The delays in closing the fuel injector are caused by adhesion forces acting between the armature and the magnetic coil core and by the not instantly occurring decay of the magnetic field when the field current is switched off. That is why the restoring spring has to have a large spring constant or a large initial stress. The restoring force for achieving short closing times has to be dimensioned substantially larger than would be required for sealing against combustion chamber pressure. This calls for great power requirement in the control circuit.

From DE 195 34 445 C2 a fuel injector for internal combustion engines is known which can be actuated by a piezoelectric actuator. The fuel injector includes a valve needle axially movable in a housing body, which can be actuated by a piezoelectric actuator and is held in a closing position by a compression spring. The housing body has a central boring in which the piezoelectric actuator is situated, so that the actuator, in turn, concentrically surrounds the valve needle and is sealed against fuel pressure by sealing surfaces. To activate the fuel injector, an electrical voltage is applied to the piezoelectric actuator, which thereby experiences a change of length, which is transmitted by the valve needle to the valve-closure member, and thereby opens the fuel injector.

The trouble with the fuel injector known from DE 195 34 445 C2 is especially its high manufacturing cost. Piezoelectric actuators are distinguished by their high sensitivity to lateral forces, so that production and installation of these components is effortful and costly.

Another disadvantage of piezoelectrically or electromagnetically operable fuel injectors is the development of much noise, caused by the mechanical impact of the valve needle on the sealing seat or the impact of the armature on the core, respectively. Besides that, setting of the stroke is required.

### SUMMARY OF THE INVENTION

Compared to that, the fuel injector according to the present invention, having the features of the main claim, has the advantage that the metering in of fuel is independent of an axial valve needle movement. Rather, the fuel is metered in by rotating the valve-closure member over the sealing member using an electric motor.

This eliminates the delay effects and the partially imprecise metered-in quantities, which are caused by the inertia of the valve needle, the bounce of the valve needle against the sealing seat or the armature against the core, respectively. Furthermore, only little noise is developed, and setting the stroke is not required.

Advantageous further refinements of the fuel injector specified in the main claim are rendered possible by the measures given in the dependent claims.

The position sensor required for the reliable angular setting of the valve-closure member relatively to the sealing member, which is situated on a drive shaft, can be designed as a simple, e.g. inductive, component.

Because of the variable size and number of discharge openings, the valve-closure member can easily be adjusted to the requirements placed upon the metered in fuel quantity. A further setting of the quantity of fuel to be ejected can be done via the rotational speed.

The valve-closure member is advantageously made of an alloy of iron and/or silicon and/or copper-beryllium, which are very hard and have good frictional properties, so that the closing body and the valve-closure member can be rotated on each other almost without abrasion. In the preferably disk-shaped valve-closure member, besides the discharge opening, advantageously a cut-out is provided for weight counterbalance.

### BRIEF DESCRIPTION OF THE DRAWING

An exemplary embodiment of the present invention is represented in simplified form in the drawing, and is explained in detail in the following description.

The figures show:

FIG. 1 shows an axial section of an exemplary embodiment of a fuel injector according to the present invention; and

FIG. 2 the section, denoted as II-II in FIG. 1, through the discharge end of the exemplary embodiment illustrated in FIG. 1 of the fuel injector according to the present invention.

### DESCRIPTION OF THE EXEMPLARY EMBODIMENT

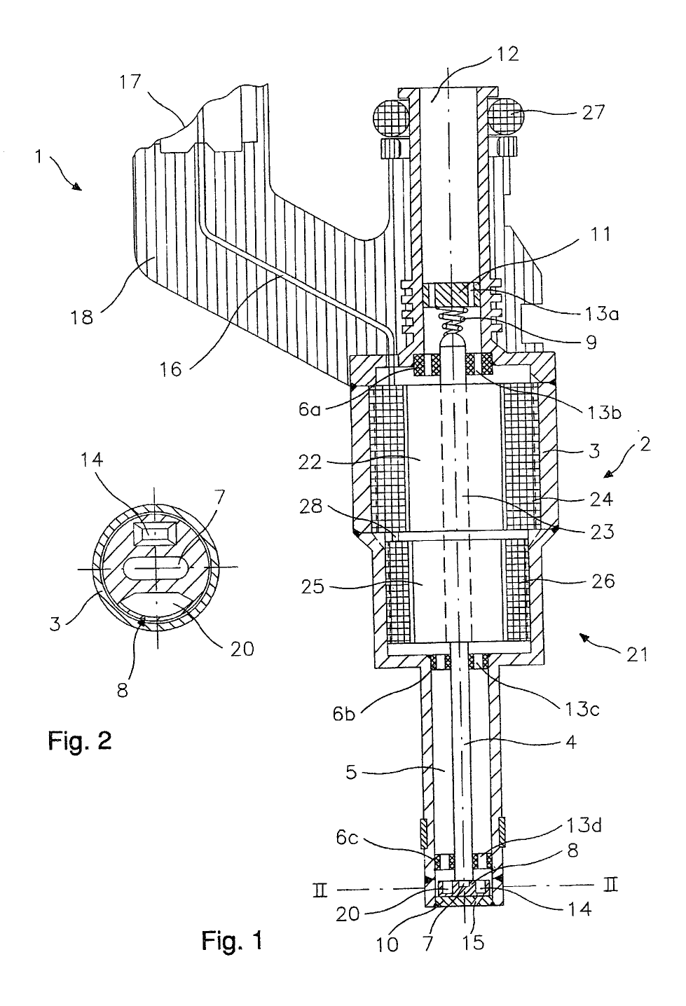

FIG. 1 shows in axial section an exemplary embodiment of a fuel injector 1 according to the present invention which is especially suitable for directly injecting fuel into a combustion chamber (not shown) of a mixture-compressing, positive ignition internal combustion engine.

Fuel injector 1 includes as operating device an electric motor 2 designed, for example, as a stepper motor, squirrel-cage motor, alternating current motor or frequency-regulated motor. In the present exemplary embodiment, the electric motor is designed as a stepper motor. Electric motor 2 is constructed from a permanent magnet 22 as rotor, having a plurality of magnetic poles which are situated symmetrically about a central boring 23, and which alternate in their polarity, and a winding 24. During assembly of fuel injector 1, electric motor 2 is installed as a prefabricated component into a sleeve-shaped valve housing 3.

Electric motor 2 drives a drive shaft 4 which reaches through central boring 23 of electric motor 2. Drive shaft 4 is situated in a central recess 5 of fuel injector 1, and is held in a central position by guide elements 6a, 6b and 6c. At its discharge end, drive shaft 4 engages with a driving slot 7 of a preferably disk-shaped valve-closure member B. At its inlet end, drive shaft 4 is acted upon by a pressure spring 9, which holds drive shaft 4, and thereby valve-closure member 8, against sealing member 10 developed as an apertured spray disk, which closes valve housing 3 in the discharge direction. Pressure spring 9 is prestressed by a prestress bushing 11 which can be pressed into especially the central recess 5 of fuel injector 1.

Downstream from electric motor 2 a position sensor 21 is situated on drive shaft 4. The position sensor is used for the precise switching between the different positions of drive shaft 4. This is especially important when electric motor 2 is not designed as a stepper motor. This position sensor 21 is constructed as an induction sensor from an inner permanent magnet 25 and an outer winding 26, and is situated, just like electric motor 2, in recess 5 of fuel injector 1.

Fuel is directed centrally via a fuel supply 12 as well as fuel channels 13a in the prestress bushing 11. It continues to flow via fuel channels 13b, 13c, and 13d in guide elements 6a, 6b and 6c through central recess 5 of fuel injector 1 to sealing element 10. In doing so, the fuel flows around electric motor 2 positioned in central recess 5 of fuel injector 1 and around position sensor 21 on its outer sides, electric motor 2 and position sensor 21 being expediently enclosed against the fuel, since otherwise the chemical aggressiveness of the fuel could possibly lead to damage of the electrical components. The fuel flows through at least one discharge opening 14 in valve-closing member 8 as well as one spray-discharge opening 15 in sealing body 10, and is injected from there directly into the combustion chamber (not shown). Injecting fuel into an intake manifold of an internal combustion engine is also possible with the fuel injector according to the present invention.

For the operation of electric motor 2, the fuel injector has an electric line 16 which leads to a plug contact 17. Plug contact 17 can have a further contact for contacting position sensor 21, to which an electrical line 28 leads. Plug contact 17, electrical line 16 and the intake part of fuel injector 1 are surrounded by a plastic jacket 18, which can preferably be applied by extrusion-coating. Fuel injector 1 is sealed by a sealing element 27.

FIG. 2 shows in sectional view, in excerpted form, a radial section along line II-II in FIG. 1. The same components are shown here with identical reference numerals.

The section through valve housing 3 at the height of valve-closing member 8 shows an exemplary embodiment of the positioning of discharge opening 14, driving slot 7 as well as a cut-out 20 in valve-closure member 8. Cut-out 20, in the shape of a sector of a circle, for example takes care, by way of weight counterbalance, of uniformly even movement of valve-closure member 8 on sealing body 10. Cut-out 20 does not go all the way through the disk-shaped valve-closing member 8, so that there is no fuel flow through cut-out 20.

Fuel entering from the inlet side, which flows through guide element 6c by way of fuel channels 13d goes through valve-closure member 8 via discharge opening 14 and is injected into the combustion chamber of the internal combustion engine via ejection opening 15 put into sealing body 10.

In the present exemplary embodiment, valve-closure member 8 has a discharge opening 14 and a corresponding cut-out for weight counterbalance. Depending on the requirements on the quantity of fuel to be metered in, a plurality of discharge openings 14 can also be present in valve closure member 8. When there are two discharge openings 14, the second discharge opening 14 can be fitted in, in place of cut-out 20 for weight counterbalance, and three or more discharge openings 14 are correspondingly arranged in symmetrical fashion.

To operate fuel injector 1, an electrical operating voltage is applied to plug contact 17 and directed to electric motor 2 via electric line 16.

Two operating types are possible for operating fuel injector 1. At rotational speeds of more than ca. 4,500 revolutions per minute in so-called homogeneous operation of the internal combustion engine, fuel injector 1 is operated by rotation of valve-closing member 8. That means, that electric motor 2 drives drive shaft 4 without interruption, and that thereby valve-closure member 8 is likewise set in uninterrupted rotation. Because of that, at each revolution of valve-closure member 8, when discharge opening 14 of valve-closure member 8 is located coincident to discharge opening 15 of sealing body 10, a defined quantity of fuel is injected into the combustion chamber. Thus, the quantity of fuel is dependent on the rotational speed of valve-closure member 8 as well as the size of discharge opening 14 and ejection opening 15.

If a smaller quantity of fuel is to be measured in, for example, in a rotational speed range under ca. 4,500 revolutions per minute in the stratified operation of the internal combustion engine, fuel injector 1 is operated by turning it back and forth. To do this, electric motor 2 switches valve-closure member 8 back and forth between two positions at a switching frequency adapted to the rotational speed In this way valve-closure member 8 either takes up an open position in which discharge opening 14 lies coincident above discharge opening 15 and fuel is injected into the combustion chamber of the internal combustion engine, or it takes up a closed position, in which discharge opening 14 of valve-closure member 8 and ejection opening 15 of sealing body 10 are not coincident, and therefore no fuel can flow away. Because of that, a small quantity of fuel is conducted through discharge opening 14 in valve-closure member 8 and ejection opening 15 in sealing body 10 only at certain times. In this instance, the quantity of fuel metered in depends only on the size of discharge opening 14 and ejection opening 15 and the switching frequency. If, for example, the number of discharge openings 14 in valve-closure member 8 is doubled, the pulse frequency, or rather the rotational frequency, can be halved.

The present invention is not limited to the depicted exemplary embodiments, and can be realized for several other methods of constructing fuel injectors 1.

What is claimed is:

1. A fuel injector (1), especially a fuel injector (1) for directly injecting fuel into a combustion chamber of an internal combustion chamber, comprising a valve-closure member (8), which forms a sealing seat with a sealing body (10), and an operating device for operating the valve-closure member (8),
wherein the operating device is an electric motor (2) which opens and closes the fuel injector (1) by rotating the valve-closure member (8).

2. The fuel injector as recited in claim 1,
wherein the sealing body (10) of the fuel injector (1) seals in the spray-dischrge direction and has at least one spray orifice (15).

3. The fuel injector as recited in claim 1 or 2,
wherein the electric motor (2) is situated in a central recess (5) of the fuel injector (1).

4. The fuel injector as recited in one of claims 1 through 3,
wherein a drive shaft (4) connects the electric motor (2) with force locking to the valve-closure member (8).

5. The fuel injector as recited in claim 4,
wherein the drive shaft (4) is acted upon by a pressure spring (9) at its intake end.

6. The fuel injector as recited in claim 4 or 5,
wherein the valve-closure member (8) has a disk-shaped design, and has a central driving slot (7), into which the drive shaft (4) engages at its spray-discharge end.

7. The fuel injector as recited in claim 6,
wherein the valve-closure member (8) has at least one discharge orifice (14) and at least one closed cut-out (20) for weight counterbalance.

8. The fuel injector as recited in claim 7, wherein the discharge orifice (14) and the cut-out (20) are positioned diametrically opposite one another in the valve-closure member (8), with respect to the central driving slot.

9. The fuel injector as recited in one of claims 4 through 8,
wherein a position sensor (21) is positioned on the drive shaft (4) of the fuel injector (1).

10. The fuel injector as recited in claim 9,
wherein the drive shaft (4) engages centrally through the position sensor (21).

11. The fuel injector as recited in claim 10,
wherein the position sensor (21) is an inductive position sensor (21) and has a winding (26).

12. The fuel injector as recited in one of claims 1 through 11,
wherein the valve-closure member (8) is made of an alloy of iron and/or of silicon and/or of copper-beryllium.

13. The fuel injector as recited in one of claims 1 through 12,
wherein the electric motor (2) is designed as a stepper motor.
